(19) United States
(12) Patent Application Publication
(10) Pub. No.: US 2026/0095833 A1
(43) Pub. Date: Apr. 2, 2026

(54) CELLULAR NETWORK MOBILITY MANAGEMENT BASED ON USER EQUIPMENT MEASUREMENTS

(71) Applicant: GM Global Technology Operations LLC, Detroit, MI (US)

(72) Inventors: Sheng Liu, Novi, MI (US); Chuan Li, Troy, MI (US); Fan Bai, Ann Arbor, MI (US); Yohay Buchbut, Pardes Hanna (IL); Scott Thomas Droste, West Bloomfield, MI (US); David M. George, Novi, MI (US)

(21) Appl. No.: 18/901,312

(22) Filed: Sep. 30, 2024

(51) Int. Cl. H04W 36/24; H04W 36/30

(52) U.S. Cl. CPC H04W 36/249; H04W 36/30

(57) ABSTRACT

A system for cellular network mobility management based on user equipment measurements includes a host device, cellular communication cells, and a back office. The host device, cellular communication cells and back office execute a cellular network mobility management application (CMMA). The CMMA as initiated by the host device, generates control-plane measurement event based handover suggestions, generates quality-of-service (QoS) measurement based handover suggestions. Then the CMMA, via the cellular communication cells, performs cellular network signal strength monitoring and determines that a measurement configuration (MC) threshold has been achieved. Subsequently, the system performs anomaly detection; and selectively alters timing of cellular network handovers between the host device and the one or more cellular communication cells to reduce a potential for repetitive handovers from a first level to a second level less than the first level while maintaining or improving a cellular network QoS.

### INTRODUCTION

The present disclosure relates to mobility systems and methods, and more specifically to systems and methods for managing cellular network mobility adjustment based on user equipment (UE) measurement information.

Maintaining cellular network connectivity, including cellular connection consistency, is becoming increasingly important as the quantity of cellular systems increases and more systems and devices become reliant upon cellular network connections. As cellular network-connected devices move, the devices come into proximity with one or more cellular transmitters and receivers such as cells. Handovers between such cellular transmitters and receivers allow the cellular network-connected devices to maintain cellular connectivity. However, handovers between cellular transmitters and receivers and the like can be impacted by signal strength and quality fluctuations, which may result in additional unwanted transfers or handovers between the cellular transmitters and receivers.

Accordingly, while current systems and methods for cellular network mobility management achieve their intended purpose, there is a need for new and improved systems for cellular mobility management that utilize UE measurement information to minimize unnecessary handovers between cellular transmitters and receivers, provide for increased signal strength, reduce quality of service (QoS) degradation, forecast handovers and pre-execute and/or post postpone handovers based on a-priori information, while maintaining or reducing system complexity, reducing manufacturing complexity, and increasing system reliability.

### SUMMARY

According to several aspects, a system for cellular network mobility management based on user equipment measurements includes a host device, one or more cellular communication cells, and a back office. The system further includes one or more controllers. The one or more controllers are disposed within the host device and within the back office. Each of the one or more controllers has a processor, a memory, and input/output (I/O) ports. The processor executes programmatic control logic stored in the memory. The I/O ports are in wireless communication via a cellular network with the one or more cellular communication cells and the back office. The programmatic control logic includes a cellular network mobility management application (CMMA). The CMMA includes at least a first, second, third, and fourth control logic. The first control logic, initiated by the host device, generates control-plane measurement event based handover suggestions. The second control logic, initiated by the host device, generates quality-of-service (QoS) measurement based handover suggestions. The third control logic, initiated by the one or more cellular communication cells, performs cellular network signal strength monitoring and determines that a measurement configuration (MC) threshold has been achieved. Outputs of the third control logic are further modified by the fourth control logic that performs anomaly detection; and in response to outputs of the first control logic, the second control logic, the third control logic, and the anomaly detection, the system selectively alters timing of cellular network handovers between the host device and the one or more cellular communication cells to reduce a potential for repetitive handovers from a first level to a second level less than the first level while maintaining or improving a cellular network QoS.

In another aspect of the present disclosure, the memory further includes one or more databases of the back office storing prior knowledge, the prior knowledge including historical information from the host device and from other devices communicating on the cellular network, the historical information comprising: QoS information, cellular network signal strength information, and host device state information. The host device state information includes: static and dynamic information about the host device including velocity, distance from the host device to a suggested handover location, a host device location, and a network signal strength and network condition at a current host device location.

In another aspect of the present disclosure the first control logic further includes control logic that receives a radio resource control (RRC) message from at least one cellular communication cell of the cellular network and control logic that, based on the RRC message generates an original MC and transmits the original MC to the host device. The first control logic further includes control logic that identifies events and event thresholds relevant to identified events, the event thresholds stored in the memory.

In another aspect of the present disclosure the first control logic further includes control logic for performing event-based threshold modification utilizing the identified events and event thresholds; and control logic for determining a handover suggestion. The handover suggestion includes at least one of: preponing a handover, postponing a handover, canceling a handover, and adding a handover.

In another aspect of the present disclosure the event-based threshold modification further includes control logic for generating a suggested MC that causes a measurement report (MR) for each monitored physical cell to trigger at time tₛ(1), and based on the MR, initiates a handover at time tₛ(2), in context, t(2)=t(1)⁺, defines that a handover occurs at t(2) takes place shortly after t(1), where t(1) is the time at which the MR is triggered such that:
a preponed handover is defined as: tₛ(2)<tₒ(2);
a postponed handover is defined as: tₛ(2)>tₒ(2);
a cancelled handover is defined as: tₛ(1)=inf;
and adding a handover is defined as: ∃tₛ(2) when [symbol] tₒ(2),
   where tₒ(2) indicates the timing of the original handover.

In another aspect of the present disclosure the second control logic further includes control logic for monitoring cellular network QoS, and upon determining that a predetermined QoS threshold has not been met, continues QoS monitoring, and upon determining that the predetermined QoS threshold has been met, engages a determinator control logic, wherein the cellular network QoS includes data throughput, end-to-end latency, jitter, and communication reliability.

In another aspect of the present disclosure the second control logic further includes control logic that monitors cellular network signal strength as reference signal perceived power (RSRP), and upon determining that predetermined signal strength thresholds have not been met, continues RSRP monitoring, and upon determining that the predetermined signal strength thresholds have been met, engages the determinator control logic. The second control logic further includes control logic that determines whether events have met MC thresholds set in an original MC, and upon determining that the MC thresholds have not been met, continues RSRP monitoring, and upon determining that the MC thresholds have been met, triggers an MR.

In another aspect of the present disclosure the determinator control logic further includes control logic that incorporates a QoS metric within decision-making criteria for the MR. When QoS metrics fall below Q_{θ} prior to RSRP decreasing enough to trigger a handover according to the MC thresholds in the original MC, a handover process is advanced or preponed, when QoS metrics fall below Qₘᵢₙ, the control-plane events that responsible for emergency handover are kept or created in the MC, and the handover process is advanced or preponed, and when QoS metrics are above Qₘᵢₙ, and RSRP anomalies are detected, then the handover process is cancelled or postponed, wherein RSRP anomalies define short duration signal strength fluctuations, Qₘᵢₙ is a predetermined minimum QoS, and Q_{θ} is a predetermined threshold QoS greater than Qₘᵢₙ.

In another aspect of the present disclosure the second control logic further includes control logic for detecting repetitive unnecessary handovers or ping-pong handovers between cells such that for a physical cell identity (PCI) at time T: P(T),
If ∃T_{AB}, T_{BA} such that:

$$P ( {T}_{A B} ) = A and P ( {T}_{A B}^{+} ) = B ;$$

$$P ( {T}_{B A} ) = B and P ( {T}_{B A}^{+} ) = A ;$$

$${T}_{B A}^{+} - {T}_{A B} < t ,$$

then: Ping-Pong=True.

In another aspect of the present disclosure the third control logic further includes control logic for adjusting a location of a handover between cellular communication cells upon detection of a ping-pong handover such that:
If Ping-Pong=True:

$$A {3}_{θ} := min ( A {3}_{θ} + ( \frac{{w}_{v}}{V + ϵ} ) ( {w}_{d} D ) , A {3}_{θ} + {Δ}_{max} ) ,$$

where v=velocity, D=estimated distance to a heatmap+host device trajectory, wᵥ=velocity weight, ϵ=small constant, w_{d}=distance weight, Δₘₐₓ=a maximum allowed modification, where wᵥ, w_{d}, Δₘₐₓ≥0,ϵ>0.

In another aspect of the present disclosure a method for cellular network mobility management based on user equipment measurements includes: executing programmatic control logic including a cellular network mobility management application (CMMA) stored in memory of one or more controllers, the one or more controllers disposed within a host device and within a back office. Each of the one or more controllers has a processor, a memory, and input/output (I/O) ports, the processor executing the programmatic control. The I/O ports are in wireless communication via a cellular network with the one or more cellular communication cells and the back office. The CMMA includes control logic for: generating, by the host device, control-plane measurement event based handover suggestions; generating, by the host device, quality-of-service (QoS) measurement based handover suggestions; and performing, by the one or more cells, cellular network signal strength monitoring and determining that a measurement configuration (MC) threshold has been achieved. The CMMA further includes control logic for performing anomaly detection; and selectively altering timing of cellular network handovers between the host device and the one or more cellular communication cells to reduce a potential for repetitive handovers from a first level to a second level less than the first level while maintaining or improving a cellular network QoS.

In another aspect of the present disclosure the method further includes storing, with one or more databases of the back office, prior knowledge, the prior knowledge including historical information from the host device and from other devices communicating on the cellular network. The historical information includes: QoS information, cellular network signal strength information, and host device state information. The host device state information includes: static and dynamic information about the host device including velocity, distance from the host device to a suggested handover location, a host device location, and a network signal strength and network conditions at a current host device location.

In another aspect of the present disclosure the method further includes receiving a radio resource control (RRC) message from at least one cellular communication cell of the cellular network, generating, based on the RRC message, an original MC and transmitting the original MC to the host device; and identifying events and event thresholds relevant to identified events, the event thresholds stored in the memory.

In another aspect of the present disclosure the method further includes performing control-plane event-based threshold modification utilizing the identified events and event thresholds, and determining a handover suggestion. The handover suggestion includes at least one of: preponing a handover, postponing a handover, canceling a handover, and adding a handover.

In another aspect of the present disclosure the method further includes generating a suggested MC that causes measurement report (MR) for each monitored physical cell to trigger at time tₛ(1), and based on the MR, initiating a handover at time tₛ(2). In context, t(2)=t(1)⁺, defines that a handover occurs at t(2) takes place shortly after t(1), where t(1) is a time at which the MR is triggered such that:
a preponed handover is defined as: tₛ(2)<tₒ(2);
a postponed handover is defined as: tₛ(2)>tₒ(2);
a cancelled handover is defined as: tₛ(1)=inf; and
adding a handover is defined as: ∃tₛ(2) when [symbol] tₒ(2).

In another aspect of the present disclosure the method further includes monitoring cellular network QoS, and upon determining that a predetermined QoS threshold has not been met, continuing QoS monitoring, and upon determining that the predetermined QoS threshold has been met, engaging a determinator control logic, wherein the cellular network QoS includes data throughput, end-to-end latency, jitter, and communication reliability).

In another aspect of the present disclosure the method further includes monitoring cellular network signal strength as reference signal perceived power (RSRP), and upon determining that predetermined signal strength thresholds have not been met, continuing RSRP monitoring, and upon determining that the predetermined signal strength thresholds have been met, engaging the determinator control logic; and determining whether events have met MC thresholds set in an original MC, and upon determining that the MC thresholds have not been met, continuing RSRP monitoring, and upon determining that the MC thresholds have been met, triggering an MR.

In another aspect of the present disclosure the method further includes incorporating a QoS metric within decision-making criteria for the MR. The method further includes advancing or preponing a handover process when QoS metrics fall below Q_{θ} prior to RSRP decreasing enough to trigger a handover according to the MC thresholds in the original MC, advancing or preponing the handover process when QoS metrics fall below Qₘᵢₙ, only a portion of events are kept in the MC, and cancelling or postponing the handover process when QoS metrics are above Qₘᵢₙ, and RSRP anomalies are detected. RSRP anomalies define short duration signal strength fluctuations, Qₘᵢₙ is a predetermined minimum QoS, and Qo is a predetermined threshold QoS greater than Qₘᵢₙ.

In another aspect of the present disclosure the method further includes detecting repetitive unnecessary handovers or ping-pong handovers between cells such that for a physical cell identity (PCI) at time T: P(T),

$$When ∃ {T}_{A B} , {T}_{B A} such that :$$

$$P ( {T}_{A B} ) = A and P ( {T}_{A B}^{+} ) = B ;$$

$$P ( {T}_{B A} ) = B and P ( {T}_{B A}^{+} ) = A ;$$

$${T}_{B A}^{+} - {T}_{A B} < t ,$$

then: Ping-Pong=True; and
adjusting a location of a handover between cells upon detection of a ping-pong handover such that:
   When Ping-Pong=True:

$$A {3}_{θ} := min ( A {3}_{θ} + ( \frac{{w}_{v}}{V + ϵ} ) ( {w}_{d} D ) , A {3}_{θ} + {Δ}_{max} ) ,$$

where v=velocity, D=estimated distance to a heatmap+host device trajectory, wᵥ=velocity weight, ϵ=small constant, w_{d}=distance weight, Δₘₐₓ=a maximum allowed modification, where wᵥ, w_{d}, Δₘₐₓ≥0,ϵ>0.

In another aspect of the present disclosure the method further includes a method for cellular network mobility management based on user equipment measurements includes executing programmatic control logic including a cellular network mobility management application (CMMA) stored in memory of one or more controllers, the one or more controllers disposed within a host device and within a back office. Each of the one or more controllers has a processor, a memory, and input/output (I/O) ports, the processor executing the programmatic control, the I/O ports in wireless communication via a cellular network with the one or more cellular communication cells and the back office. The CMMA includes control logic for: generating, by the host device, measurement event based handover suggestions, including: storing, with one or more databases of the back office, prior knowledge, the prior knowledge including historical information from the host device and from other devices communicating on the cellular network, the historical information comprising: QoS information, cellular network signal strength information, and host device state information. The host device state information includes: static and dynamic information about the host device including velocity, distance from the host device to a suggested handover location, a host device location, and a network signal strength and network condition at a current host device location. The CMMA further includes control logic for receiving a radio resource control (RRC) message from at least one cellular communication cell of the cellular network, generating, based on the RRC message, an original MC and transmitting the original MC to the host device, and for identifying events and event thresholds relevant to identified events, the event thresholds stored in the memory. The CMMA further includes control logic for performing control-plane event-based threshold modification utilizing the identified events and event thresholds and determining a handover suggestion. The handover suggestion includes at least one of: preponing a handover, postponing a handover, canceling a handover, and adding a handover. The CMMA further includes control logic for generating a suggested MC that causes measurement report (MR) for each monitored physical cell to trigger at time tₛ(1), and based on the MR, initiating a handover at time tₛ(2), in context, t(2)=t(1)⁺, defines that a handover occurs at t(2) takes place shortly after t(1), where t(1) is the time at which the MR is triggered) such that:
a preponed handover is defined as: tₛ(2)<tₒ(2);
a postponed handover is defined as: tₛ(2)>tₒ(2);
a cancelled handover is defined as: tₛ(1)=inf;
and adding a handover is defined as: ∃tₛ(2) when [symbol] tₒ(2);
   The CMMA further includes control logic for generating, by the host device, quality-of-service (QoS) measurement based handover suggestions, and performing, by the one or more cells, cellular network signal strength monitoring and determining that a measurement configuration (MC) threshold has been achieved, including: monitoring cellular network QoS, and upon determining that a predetermined QoS threshold has not been met, continuing QoS monitoring, and upon determining that the predetermined QoS threshold has been met, engaging a determinator control logic. The cellular network QoS includes data throughput, end-to-end latency, jitter, and communication reliability; monitoring cellular network signal strength as reference signal perceived power (RSRP). Upon determining that predetermined signal strength thresholds have not been met, the CMMA continues RSRP monitoring, and upon determining that the predetermined signal strength thresholds have been met, the CMMA engages the determinator control logic. The CMMA further includes control logic for determining whether events have met MC thresholds set in an original MC, and upon determining that the MC thresholds have not been met, continuing RSRP monitoring, and upon determining that the MC thresholds have been met, triggering an MR. The CMMA further includes control logic for incorporating a QoS metric within decision-making criteria for the MR, including: advancing or preponing a handover process when QoS metrics fall below Q_{θ} prior to RSRP decreasing enough to trigger a handover according to the MC thresholds in the original MC, advancing or preponing the handover process when QoS metrics fall below Qₘᵢₙ, a portion of the control-plane events that are responsible for emergency handover are kept or created in the MC, and cancelling or postponing the handover process when QoS metrics are above Qₘᵢₙ, and RSRP anomalies are detected. RSRP anomalies define short duration signal strength fluctuations, Qₘᵢₙ is a predetermined minimum QoS, and Q_{θ} is a predetermined threshold QoS greater than Qₘᵢₙ. The CMMA further includes control logic for detecting repetitive unnecessary handovers or ping-pong handovers between cells such that for a physical cell identity (PCI) at time T: P(T),

$$When ∃ {T}_{A B} , {T}_{B A} such that :$$

$$P ( {T}_{A B} ) = A and P ( {T}_{A B}^{+} ) = B ;$$

$$P ( {T}_{B A} ) = B and P ( {T}_{B A}^{+} ) = A ;$$

$${T}_{B A}^{+} - {T}_{A B} < t ,$$

then: Ping-Pong=True; and

performing anomaly detection; and selectively altering timing of cellular network handovers between the host device and the one or more cells to reduce a potential for repetitive handovers from a first level to a second level less than the first level while maintaining or improving a cellular network QoS by adjusting a location of a handover between cells upon detection of a ping-pong handover such that:
When Ping-Pong=True:

$$A {3}_{θ} := min ( A {3}_{θ} + ( \frac{{w}_{v}}{V + ϵ} ) ( {w}_{d} D ) , A {3}_{θ} + {Δ}_{max} ) ,$$

where v=velocity, D=estimated distance to a heatmap+host device trajectory, wᵥ=velocity weight, ϵ=small constant, w_{d}=distance weight, Δₘₐₓ=a maximum allowed modification, where wᵥ, w_{d}, Δₘₐₓ≥0,ϵ>0.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for cellular network mobility management based on user equipment measurements according to an exemplary embodiment;

FIG. 2 is a flowchart depicting logical structure of a cellular network mobility management application (CMMA) of the system of FIG. 1 according to an exemplary embodiment;

FIG. 3A is a flow diagram depicting a preponed handover scenario using the CMMA of FIG. 2 according to an exemplary embodiment;

FIG. 3B is a flow diagram depicting a delayed or cancelled handover scenario using the CMMA of FIG. 2 according to an exemplary embodiment;

FIG. 3C is a flow diagram depicting a new handover scenario using the CMMA of FIG. 2 according to an exemplary embodiment;

FIG. 4 is a flowchart depicting a first method for performing measurement events based handover between cells in the system of FIG. 1 according to an exemplary embodiment;

FIG. 5 is a flowchart depicting a second method for performing quality-of-service (QoS) measurement based handover between cells in the system of FIG. 1 according to an exemplary embodiment; and

FIG. 6 is a chart depicting three distinct handover scenarios based on QoS and signal strength in the system for cellular network mobility management based on user equipment measurements of FIG. 1 according to an exemplary embodiment.

### DETAILED DESCRIPTION

The following description is merely exemplary in nature and is not intended to limit the present disclosure, application, or uses.

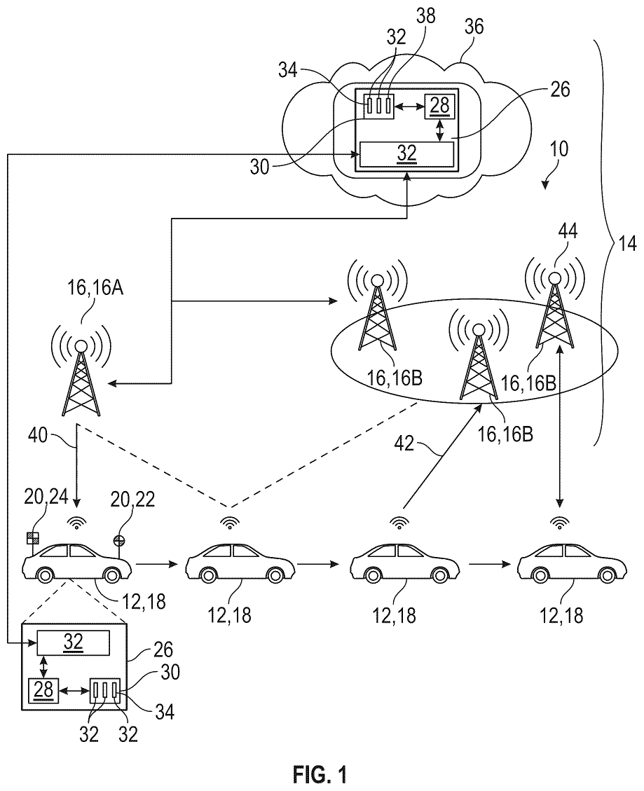

Referring to FIG. 1 a system 10 for cellular network mobility management based on user equipment (UE) measurements is shown in schematic form. The system 10 includes a host device 12 in wireless communication with a cellular network 14, including a plurality of cells 16, and in particular at least one serving cell 16A and one or more neighboring cells 16B. The host device 12 may be any of a wide variety of devices without departing from the scope or intent of the present disclosure. That is, while the host device 12 depicted in FIG. 1 and following figures is a vehicle 18, the host device 12 may be any type of device in wireless communication with the cellular network 14. In some examples, the host device 12 may be a cellular phone, a smartwatch, a medical alert device, broadband devices, and/or a computer such as a laptop, tablet or other such mobile computing device. Additionally, while the vehicle 18 is depicted as a car, it should be appreciated that the vehicle 18 may be any type of vehicle 18 having cellular connectivity, including but not limited to: cars, trucks, sport utility vehicles (SUVs), semi trucks, tractor trailers, tractors, combine harvesters and other farming equipment, powered flight and unpowered aircraft such as planes, helicopters, gliders and autogyros, powered and unpowered watercraft such as: ships, sailboats, motorboats, pleasurecraft, jet skis, canoes, and sailboats, and the like. In additional non-limiting embodiments, the system 10 described herein may be adapted to function with manned and unmanned spacecraft such as: satellites, rockets, space stations, and other orbital and extra-orbital satellite-communications-enabled devices without departing from the scope or intent of the present disclosure. The host device 12 further includes one or more sensors 20. The one or more sensors 20 may be any of a wide variety of sensor types without departing from the scope or intent of the present disclosure. In some examples, the sensors 20 may include sensors for detecting static and dynamic information about the physical state of the host device 12. Such static and dynamic state detecting sensors 20 may include: inertial measurement units (IMUs) 22; speed sensors; atmospheric condition sensors such as: hygrometers, barometers, thermometers, anemometers, and air quality sensors; global positioning system (GPS) sensors 24, and the like. IMUs 22 measure position, movement and acceleration in three or more degrees of freedom. Additional sensors 20 may include sensors for detecting static and dynamic cellular network 14 state sensors that detect and report information about cellular network 14 quality of service (QoS), and the like.

The host device 12 includes a controller 26 which is a non-generalized, electronic control device having a preprogrammed digital computer or processor 28, non-transitory computer readable medium or memory 30 used to store data such as control logic, software applications, instructions, computer code, data, lookup tables, etc., and a transceiver or input/output (I/O) ports 32. Computer readable medium or memory 30 includes any type of medium capable of being accessed by a computer, such as read only memory (ROM), random access memory (RAM), a hard disk drive, a compact disc (CD), a digital video disc (DVD), or any other type of memory 30. A “non-transitory” computer readable memory 30 excludes wired, wireless, optical, or other communication links that transport transitory electrical or other signals. A non-transitory computer readable memory 30 includes media where data can be permanently stored and media where data can be stored and later overwritten, such as a rewritable optical disc or an erasable memory device. Computer code includes any type of program code, including source code, object code, and executable code. The processor 28 is configured to execute the code or instructions.

Where the host device 12 is a motor vehicle 18, the controller 26 may include a dedicated Wi-Fi controller or an engine control module, a transmission control module, a body control module, an infotainment control module, etc. The transceiver 26 is configured to wirelessly communicate with the cellular network 14 using cellular protocols including global system for mobile communication (GSM), general packet radio service (GPRS), enhanced data rates for GSM evolution (EDGE), universal mobile telecommunications services (UMTS), high speed packet access (HSPA), code-division multiple access (CDMA), evolution-data optimized (EV-DO/EVDO/1×EV-DO), short message services (SMS), Wi-MAX, manufacturing messages specification (MMS), 2G, 3G, 4G, 5G, wireless and cellular standards as defined under IEEE 802.1X, IEEE 802 LAN/MAN, and IEEE mobile communication networks standards committee (MobiNet-SC) standards, and the like.

The host device 12 further includes one or more applications 32. An application 32 is a software program configured to perform a specific function or set of functions. The application 32 may include one or more computer programs, software components, sets of instructions, procedures, functions, objects, classes, instances, related data, or a portion thereof adapted for implementation in a suitable computer readable program code. The applications 32 may be stored within the memory 30 or in additional or separate memory. Examples of the applications 32 include audio or video streaming services, games, browsers, social media, etc., and a cellular network mobility management application (CMMA) 34.

The system 10 further includes one or more back-offices or cloud servers 36 in wireless communication with the host device 12 via one or more wireless or cellular protocols as described hereinabove. The cloud servers 36 each include one or more controllers 26 that may execute a portion of the CMMA 34 as well as storing one or more databases 38 in memory. The databases 38 may include a variety of different types of data without departing from the scope or intent of the present disclosure, but in a non-limiting example, the databases 38 include metrics used by the CMMA 34 to determine when, if, and how handovers between cells 16 should be accomplished. It will be appreciated that the metrics may be predetermined, constant, variable, constantly updated, periodically updated, and/or updated upon the occurrence of one or more events without departing from the scope or intent of the present disclosure.

In the system 10 of the present disclosure, a host vehicle 18 or other such host device 12 communicates with the cellular network 14 and receives a variety of data from the cellular network 14. The serving cell 16A transmits measurement configurations (MC) 40 including a set of parameters that detail of which physical cells or cells 16 the cellular network 14 is instructing the host device 12 or other such user equipment (UE) to keep track. Additionally, the MC 40 includes specific events that may trigger the host device 12 to generate and send a measurement report (MR) 42 for each monitored physical cell or cell 16. The system 10 then augments standard base station (BS) 44 dominated handover mechanisms to utilize a UE-assisted approach to initiate handover procedures. The UE-assisted approach utilizes full user-experienced quality-of-service (QoS) metric arrays into handover considerations rather than relying solely on RSRP values. In several aspects, the cellular network 14 QoS metrics include data throughput, end-to-end latency, jitter, and communication reliability.

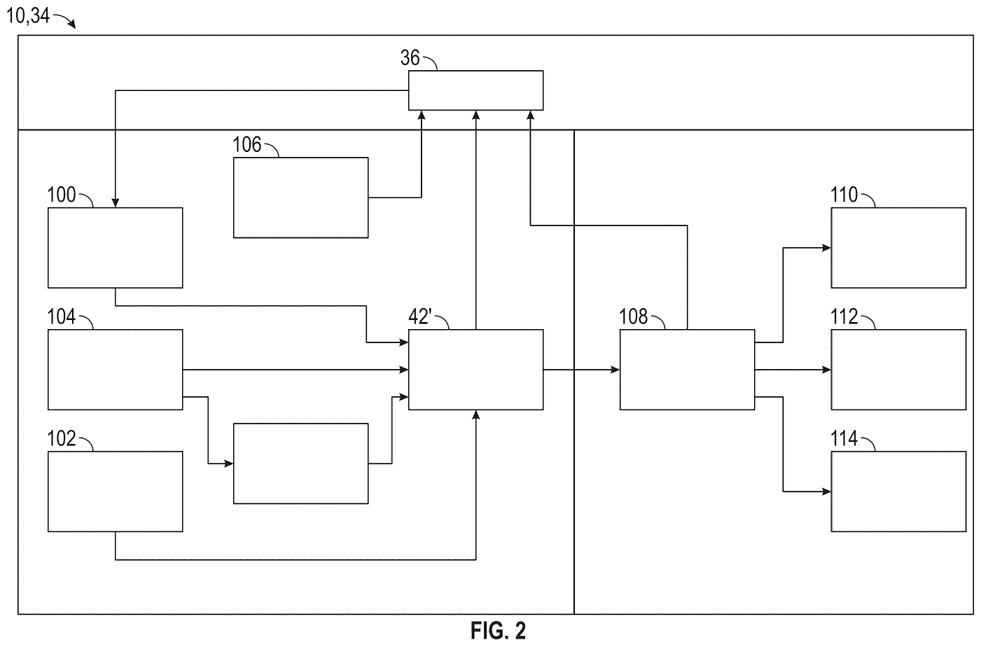

Turning now to FIG. 2 and with continuing reference to FIG. 1, the CMMA 34 is shown in further detail in flowchart form. The CMMA 34 utilizes a variety of different data to determine when, if, and how host device 12 communications handovers between cells 16 are accomplished. Input data used to make handover scheduling determinations include prior knowledge 100, QoS measurements 102 which augment signal strength or reference signal perceived power (RSRP) measurements 104 to generate an updated MR 42′.

The prior knowledge 100 includes information from the host device 12 and other devices functioning on the cellular network 14 and reporting to the system 10 that indicate whether cellular network 14 services are functioning well. That is, the prior knowledge 100 includes negative and/or positive reports about cellular network 14 functionality from prior host devices 12 in a particular area. QoS measurements 102 may include a wide variety of data relating to the cellular network 14 functionality. The QoS measurements 102 determine whether the cellular network 14 QoS is functioning at, above, or below a predefined and/or variable threshold level of performance Q_{θ}.

Signal strength measurements 104 may include a variety of different types of data, but in a non-limiting example, a measured signal amplitude may define at least a portion of the signal strength measurements 104. As applied to the MR 42 of the present disclosure, the signal strength measurements 104 are signal strength-based mechanisms used in combination with the prior knowledge 100 and QoS measurements 102 to trigger transmission of an MR 42. The MR 42 includes all signal strength measurements as directed by the MC 40. The cellular network 14 leverages the information in the MR 42 to execute handover procedures. In a specific non-limiting example, when a signal strength of a neighboring cell 16B is offset higher than the signal strength of the serving cell 16A (i.e. θ=3 dB), an A3 event is triggered causing the system 10 to check the prior knowledge 100 and QoS measurements 102 to determine whether a handover to the neighboring cell 16B from the serving cell 16A is appropriate, given the current situation. It should be appreciated that while A3 events (i.e. events where neighboring cells 16B become offset better than the serving cell 16A), the system 10 and CMMA 34 of the present disclosure contemplate other events and event thresholds as well. Additional events may be defined on the LTE MR 42 triggering scale, such as: A1, where the serving cell 16A becomes better than the threshold; A2, where the serving cell 16A becomes worse than the threshold; A3; A4, where neighboring cells 16B become better than the threshold; A5, where a serving cell 16A becomes worse than a first threshold and a neighboring cell 16B becomes better than a second threshold different from the first threshold; A6, where the neighboring cell 16B becomes offset better than the serving cell 16A, and the like.

In exemplary host device 12, state information 106 is recorded by sensors 20 onboard the host device 12 or other such UE and is subsequently transmitted to the cloud server 36 along with the host device 12 updated MR 42′. The updated MR 42′ is also transmitted to a cellular network 14 base station 44 where handover adjustments 108 are actively, dynamically, and selectively made. Cellular network 14 base stations 44 are typically fixed transceivers that are the main communication point for one or more wireless mobile client devices or, as in the instant disclosure, host devices 12. Base stations 44 may include variable quantities of cells in the cellular network 14. In some examples a serving cell 16A and neighboring cell 16B may, in fact, be a single base station 44 cell 16 having multiple cells. Handover adjustments 108 may include commands to cancel a redundant handover 110, adjust handover timing 112, and/or add additional handovers 114. The handover adjustments 108 are also fed back into the cloud server 36 databases 38 where the handover adjustments 108 are used in conjunction with the updated MR 42 and the host device 12 state information 106 to generate new prior knowledge 100.

These prior knowledge 100 data are transmitted to the cloud server 36 where the prior knowledge 100 data is stored in one or more of the cloud server 36-housed databases 38 for later transmission to host devices 12 which may enter the relevant location or area.

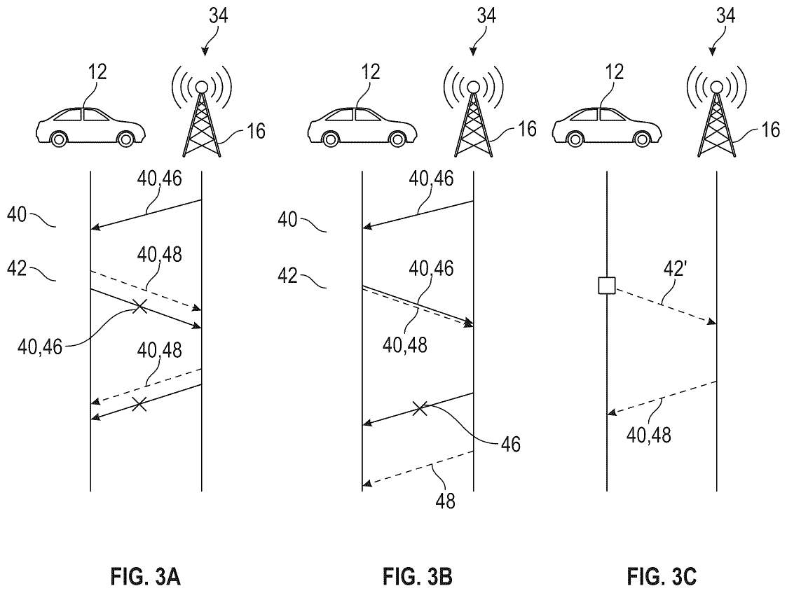

Turning now to FIGS. 3A, 3B, and 3C and with continuing reference to FIGS. 1 and 2, three exemplary handover situations are shown in additional detail.

The handover situation depicted in FIG. 3A depicts a preponed handover in which an original radio resource control (RRC) 46 message is received by the host device, carrying an original MC 40. Preponed handovers utilize the prior knowledge 100, QoS measurements 102 and signal strength measurements 104 to determine whether a threshold in an original MC 40 should be modified. More specifically, the system 10 and CMMA 34 determines that an MC 40 threshold should be modified when usage of the MC 40 threshold, if unmodified, could result in unnecessary, repetitive handovers between a serving cell 16A and one or more neighboring cells 16B as shown. Because repetitive handovers would likely result in the situation depicted in FIG. 3A, the CMMA 34 preemptively prevents the original RRC 46 containing the original MC 40 from being transmitted back to the cells 16 and instead a new RRC 48 containing a modified MC 40 is transmitted. Repetitive handovers, also known as ping-pong handovers occur when a host device 12 or UE repeatedly switches between two cells 16, such as a serving cell 16A and a neighboring cell 16B within a brief time frame “T”. Ping-pong handover detection may be characterized as: PCI at time T: P(T), where PCI is a “physical layer cell identifier” in 4G LTE and 5G NR, or the like, and used to indicate physical identity of a cell during a cell selection procedure. PCI is used for downlink synchronization. Thus:

$$\begin{matrix}If ∃ {T}_{A B} , {T}_{B A} such that : \\ P ( {T}_{A B} ) = A and P ( {T}_{A B}^{+} ) = B \\ P ( {T}_{B A} ) = B and P ( {T}_{B A}^{+} ) = A \\ {T}_{B A}^{+} - {T}_{A B} < t \\ Then : Ping - Pong = True .\end{matrix}$$

Accordingly, at time T_{AB}, the UE or host device 12 is connected with serving cell 16A, then after a short period of time indicated by

$${T}_{A B}^{+}$$

the UE or host device 12 hands over to neighboring cell 16B.

$$P ( {T}_{B A} ) = B and P ( {T}_{B A}^{+} ) = A$$

Thus, at time T_{BA}, the UE or host device 12 is connected with neighboring cell 16B, then after a short period of time indicated by

$${T}_{B A}^{+} ,$$

the UD or host device 12 hands back over to cell 16A, and:

$${T}_{B A}^{+} - {T}_{A B} < t$$

Therefore, the amount of time between which the UE or host device 12 left serving cell 16A to when the UE or host device 12 hands back over to the serving cell 16A cannot be greater than time t, otherwise a ping-pong handover is occurring. It should be appreciated that due to a variety of reasons including but not limited to infrastructure design, quantity and location of cells 16 relative to the position of the host device 12 or UE, the time t may vary substantially. However, in an exemplary, non-limiting embodiment, the time t may be defined as a quantity of time less than one second. The CMMA 34 selectively performs preponed handovers to predictively and preemptively avoid the potential for ping-pong handovers where data in an MR 42, including prior knowledge 100, QoS measurements 102 and signal strength measurements 104 indicate that ping-pong handovers are likely and have historically occurred in the location of the host device 16. When Ping-Pong=True the system 10 and CMMA 34 adjust a location of relevant handovers. The adjustment is made by modifying the value of the event-specific threshold, which is determined by the MC 40. The procedures for altering handover thresholds based on each event are outlined in Table 2. As an illustrative example, we discuss the commonly encountered A3 Event, demonstrating how its threshold is adjusted to postpone the handover. That is,

$$A {3}_{θ} := min ( A {3}_{θ} + ( \frac{{𝓌}_{v}}{V + ϵ} ) ( {𝓌}_{d} D ) , A {3}_{θ} + {Δ}_{max} )$$

v=velocity (km/h), D=estimated distance from the UE or host device 12 to the location of the UE or host device 12 suggested handover location (km). In several aspects, D may be estimated by using base station 44 signal strength heatmap+host device 12 trajectory. The maximum values of wᵥ, w_{d}, Δₘₐₓ may vary substantially from application to application as needed. However, in some an exemplary non-limiting embodiment, the ranges below may be used:

$$\begin{matrix}{𝓌}_{v} = velocity weight ( {𝓌}_{v} from 0 to 1 ) \\ ϵ = small constant ( = 0.01 ) \\ {𝓌}_{d} = distance weight ( {𝓌}_{d} from 0 to 1 ) \\ {Δ}_{max} = the maximum allowed modification ( {Δ}_{max} from 0 to 3 dB )\end{matrix}$$

Referring now more specifically to FIG. 3B, a postponed or cancelled handover is shown. Postponed or cancelled handovers are used to prevent or avoid repetitive handovers after a handover has occurred, rather than functioning preemptively based on prior knowledge. As shown in FIG. 3B, to determine whether a postponed or cancelled handover is appropriate, a serving cell 16A transmits an original MC 40 via an original RRC 46 to the host device 12, and the host device transmits both an original RRC 46 and a modified or new RRC 48 containing both the original MR 42 and a new MR 42′ to the cell 16. However, rather than receiving another original RRC message 46 containing handover instructions from the cell 16, the subsequent original RRC message 46 is cancelled, and a possible postponed new RRC 48 is transmitted selectively and situationally. Postponed or cancelled handovers result in modifications of the original MR 42 where the system 10 and CMMA 34 recommend a later timing for or a complete cancellation of a given handover between serving cells 16A and neighboring cells 16B. In several aspects, postponed handovers, like preponed handovers, result in fewer ping-pong handovers than in systems that do not use the CMMA 34 of the present disclosure.

As shown in FIG. 3C, in some circumstances, the CMMA 34 and system 10 determine that an additional handover is necessary. Accordingly, FIG. 3C depicts an added handover that is executed by the host device 12 or UE, and subsequently reported in a new MR 42′ advising the system 10 and CMMA 34 to add an additional or extra handover to prevent QoS losses and maintain signal strength as much as possible. Each of the approaches depicted in FIGS. 3A, 3B and 3C involve sending an unconventional MR 42 to a base station (BS) 44 which must be capable of understanding and recognizing the new and unconventional MR 42′ as an MR 42 suggested by the host device 12 or UE. By contrast, conventional cellular communications systems utilize BS-dominated handover mechanisms, rather than handover mechanisms and processes that are at least assisted by, and in some examples, fully initiated by the UE or host device 12.

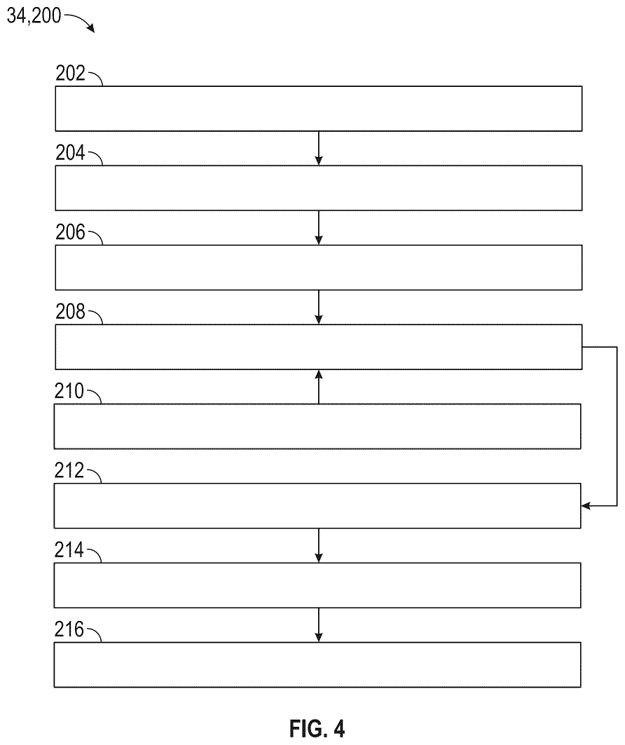

Turning now to FIG. 4 and with continuing reference to FIGS. 1-3C, a method 200 for measurement events based handover suggestions using the CMMA 34 is shown in additional detail in flowchart form. The method 200 begins at block 202 where the UE or host device 12 receives an radio resource control (RRC) message from at least one cell 16 in the cellular network 14. RRC messages include connection establishment and release functions, broadcasts of system in formation, radio bearer establishment, reconfiguration and release, RRC connection mobility procedures, paging notification and release and outer loop power control, and the like. At block 204, the serving cell 16A transmits an original MC 40 to the host device 12 as well. At block 206, the CMMA 34 identifies event and event thresholds before proceeding to block 208. At block 208, the CMMA 34 performs event based threshold modification utilizing the information from block 206, as well as handover suggestions provided at block 210. Threshold modifications or adjustments are made according to both carrier frequency and surrounding environments. Table 1 depicts exemplary ranges for adjusting thresholds when decisions are made to delay or postpone handovers for one kilometer in either urban or highway settings (i.e. when the host device 12 is moving at either urban or highway speeds and when the host device 12 is in locations where signal quality and strength may be impacted by line-of-site communications issues). It should be appreciated that the values depicted in Table 1 are merely exemplary and are not intended to limit the scope or breadth of the instant disclosure.

TABLE 1

| Frequency | Threshold adjustment Δ | Threshold adjustment Δ |
|---|---|---|
| Band Range | range in urban setting | range in highway setting |
| (GHz) | (dB/km) | (dB/km) |
| 0.5-1 | 0.5-1 | 0.1-0.3 |
| 1-2 | 0.75-1.5 | 0.2-0.5 |
| 2-3 | 1-2 | 0.3-0.7 |
| 3-4 | 1.5-2.5 | 0.5-1 |
| 4-5 | 2-3 | 0.7-1.2 |
| 5-6 | 2-3.5 | 0.9-1.5 |

Handover suggestions at block 210 may include prepone, postpone, cancel, and add, and the like, as described previously. At block 212, the CMMA 34 generates a suggested MC 40. Subsequently at block 214, the CMMA 34 causes an MR 42 to trigger at time tₛ(1), while at block 216, a handover is initiated at time tₛ(2). Under typical operating conditions, t⁺(1)=t(2), meaning handover occurs shortly after MR 42 was triggered. Based on requirements and various event types, the threshold may be modified as needed to facilitate:
Advance handover: tₛ(2)<t, (2);
Postpone handover: tₛ(2)>tₒ(2);
Cancel handover: tₛ(1)=inf; and/or
Add handover: ∃tₛ(2) when [symbol] tₒ(2).

The eight events that are currently used in cellular networks 14 are all threshold based, and by modifying the thresholds, it is possible to manage the timing of the MR 42, and the MR 42 may provide recommendations to the base station 44 to expedite, postpone, or cancel the handover process. A3 events, as described above are the most common events that trigger handovers, while A2 events typically occur in MC 42 and serves as a backup plan, activating in response to emergency situations. In several aspects, Table 2 depicts the eight events used to initiate handovers in current cellular networks 14 as well as how and when handovers are advanced (i.e. preponed), postponed, or cancelled using the system 10 and CMMA 34.

TABLE 2

| | | Advance | Postpone/Cancel |
|---|---|---|---|
| Events | Definition | Handover | Handover |
| A1 | SC RSRP > θ | θ = θ − Δ | θ = θ + Δ |
| A2 | SC RSRP < θ | θ = θ + Δ | θ = θ − Δ |
| A3, A6 | NC RSRP > SC | θ = θ − Δ | θ = θ + Δ |
| | RSRP + θ | | |
| A4, B1 | NC PSPR > θ | θ = θ − Δ | θ = θ + Δ |
| A5, B2 | SC RSRP < θ_1, | θ_1 = θ_1 + Δ; | θ_1 = θ_1 + Δ; |
| | NC RSRP > θ_2 | θ_2 = θ_2 − Δ | θ_2 = θ_2 − Δ |

The specific rules defined for each event are listed in Table 2, where “SC” denotes the serving cell, and “NC” represents the neighboring cell. For example, in the case of Event A3, the definition is NC RSRP>SC RSRP+“θ”, which means if the RSRP of the neighboring cell is “θ” dB higher than that of the serving cell, the MC will be triggered. The adjustments of “θ” or the threshold for each event, which can advance, postpone, or cancel the handover, are also detailed in Table 2. For Event A3, advancing the handover involves increasing the threshold by “Δ” dB, while postponing the handover requires decreasing the threshold by “Δ” dB. In UE-initiated measurement events-based handover suggestions, a worst-case scenario might include the host device 12 undergoing frequent ping-pong handovers while moving at low speeds. A solution provided by the system 10 and CMM 34 of the present disclosure involve postponing the handover to occur in a physical location where prior knowledge 100 indicates handovers have historically been successfully carried out without ping-pong issues. That is, when Ping-Pong=True because:

$$\begin{matrix}PCI at time T : P ( T ) \\ If ∃ {T}_{A B} , {T}_{B A} such that : \\ P ( {T}_{A B} ) = A and P ( {T}_{A B}^{+} ) = B \\ P ( {T}_{B A} ) = B and P ( {T}_{B A}^{+} ) = A \\ {T}_{B A}^{+} - {T}_{A B} < t ,\end{matrix}$$

then the system 10 and CMMA 34 adjust the physical location of the handover to avoid the ping-pong handover. That is, If Ping-Pong=True:

$$A {3}_{θ} := min ( A {3}_{θ} + ( \frac{{𝓌}_{v}}{V + ϵ} ) ( {𝓌}_{d} D ) , A {3}_{θ} + {Δ}_{max} )$$

such that v=velocity, D=estimated distance to the (heatmap+vehicle trajectory), wᵥ=velocity weight, ϵ=small constant, w_{d}=distance weight, Δₘₐₓ=the maximum allowed modification where wᵥ, w_{d}, Δₘₐₓ≥0,ϵ>0. It should be appreciated, however, that the equations above are intended only as a non-limiting exemplary embodiment, and that other derivations or adjustments of this set of equations could be used to guide such handover operations.

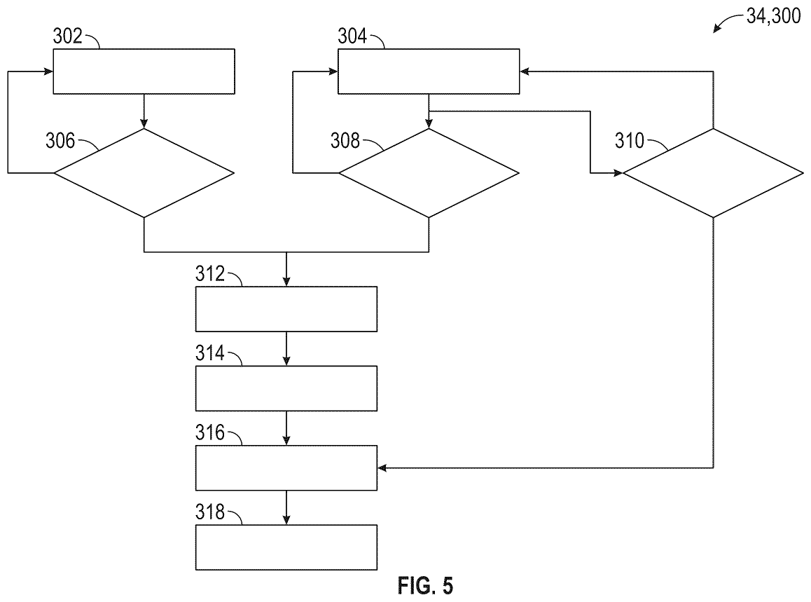

Referring now to FIG. 5 and with continuing reference to FIGS. 1-4 a method 300 for QoS measurement-based handover suggestions using the CMMA 34 is shown in additional detail in flowchart form. The QoS measurement method 300 begins at blocks 302 and 304 which may run in parallel, sequentially, simultaneously, periodically, continuously, and/or upon the occurrence of a triggering event, such as meeting an MC 40 threshold and/or the generation of or receipt of an MR 42. More specifically, at block 302, the method 300, via the UE or host device 12 executing at least a portion of the CMMA 34, performs QoS monitoring. At block 306, the CMMA 34 determines whether θq conditions have been met. θq conditions are predetermined thresholds for QoS. Upon determining that the θq conditions have not been met, the method 300 proceeds back to block 302 to continue monitoring QoS. Similarly, at block 304, the method 300, via the UE or host device 12 executing at least a portion of the CMMA 34, performs RSRP monitoring. From block 304, the method 300 proceeds to block 308 where the method determines whether Or conditions have been met. Or conditions are predefined cellular network 14 signal strength thresholds. Upon determining that the Or conditions have not been met, the method 300 returns to block 304 where the method 300 continues to perform RSRP monitoring. In addition to sending RSRP information from block 304 to block 306, the method 300 also sends RSRP information to block 310 where the method 300 determines whether MC conditions have been met. Upon determining that MC 40 conditions have not been met, the method 300 returns to block 304 and the method 300 continues to perform RSRP monitoring. In several aspects, MC 40 conditions or thresholds are indicated in an original MC 40.

However, when at either of blocks 306 or 308, the method 300 determines that the predetermined θq or θr thresholds have been met, the method 300 proceeds to block 312. Block 312 represents a determinator control logic. The determinator control logic incorporates a QoS metric within decision-making criteria for the MR 42. From block 312, the method 300 proceeds to block 314 where a suggested MC 40 is generated. Referring once more to block 310, upon determining that an MC 40 condition has been met, a signal-strength based suggested MC 40 is generated. At block 316, the QoS monitoring-based suggested MC 40 from block 314 and the signal-strength based suggested MC 40 are received, and an MR 42 is triggered. The method 300 then proceeds to block 318 where a handover, based on the newly generated MR 42 from block 316, is initiated.

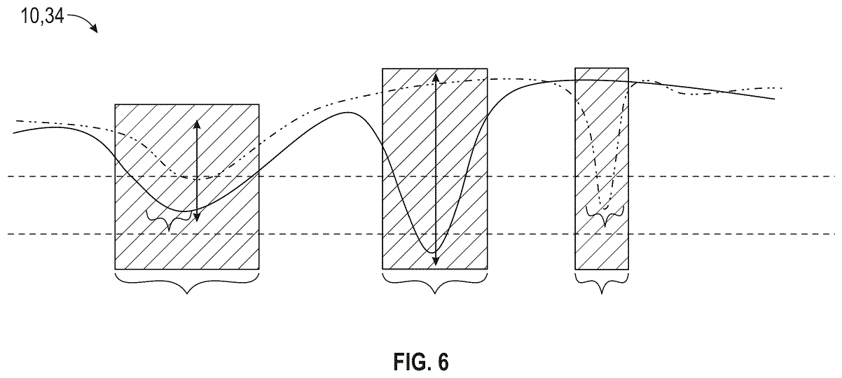

Referring now to FIG. 6, and with continuing reference to FIGS. 1-5, the QoS measurement-based handover suggestions are shown graphically with time (t) along the X-axis and signal strength and QoS metrics (Q) depicted in on the Y axis. Time (t) progresses from left to right in the diagram of FIG. 6. FIG. 6 depicts three distinct scenarios in regions A, B, and C, respectively.

Region A depicts a scenario in which when QoS metrics fall below a predetermined threshold QoS (Q_{θ}) prior to the RSRP decreasing to the level that triggers a handover, then the system 10 and CMMA 34 initiate a handover process in advance of the time t at which the handover would normally be expected to occur. Thus, Region A depicts a preponed handover where if ∀t∈[t₀, t₀+Δt], QoS(t)<Q_{θ} and RSRP(t₀+Δt)<RSRP(t₀)−k, then A3_{θ}:=A3_{θ}−Δ, where K≥0, gives weights to RSRP.

Region B depicts a scenario in which when QoS metrics fall below a predetermined minimum QoS (Qₘᵢₙ), the system 10 and CMMA 34 keep only A2 events in the MC 40, and then initiate the handover process in advance. Again, Region B depicts a preponed handover that is designed to overcome the potential QoS degradation present in a given physical location at a particular speed, and the like. Accordingly, if QoS(t)<Qₘᵢₙ, then if A2⊆MC, then MC:={A2}, A2_{θ}:=A2_{θ}+Δ.

Region C depicts a scenario in which when QoS metrics are above Qₘᵢₙ, and when RSRP anomalies are detected, the system 10 and CMMA 34 postpone or cancel a handover. In several aspects, it should be appreciated that anomalies may take any of a variety of forms, and may occur for any of a wide variety of reasons, but will typically manifest as situations in which there is a short duration signal strength fluctuation. Thus, if QoS(t)>Qₘᵢₙ and anomaly==true, then A36: =A3_{θ}+Δ(Cancel handover if Δ=inf).

A primary objective of mobility management in cellular networks 14 for CVA is to fulfill and QoS requirements. Maintaining good cellular network 14 signal strength is not the goal to achieve, but defines at least a portion of the methodology used to maintain and achieve QoS requirements. Current measurement systems primarily focus on signal strength, which may not fully align with QoS requirements. Accordingly, a determinator is employed to incorporate a QoS metric within the decision-making criteria for the MR 42. Additionally, it should be appreciated that the UE or host device 12 does not share its own QoS information to cells 16 directly. By not directly sharing QoS information, the UE or host device 12 security is improved, as UE or host device 12 physical location information, hardware information, software information, and the like are not transmitted or received directly by the system 10 and thereafter made available via MRs 42 to any other host devices 12 in the system 10.

A system 10 utilizing the CMMA 34 of the present disclosure offers several advantages. These include utilizing UE or host device 12 measurement information to minimize unnecessary handovers between cellular transmitters and receivers, provide for increased signal strength, reduce quality of service (QoS) degradation, forecast handovers and pre-execute and/or post postpone handovers based on a-priori information, while maintaining or reducing system complexity, reducing manufacturing complexity, and increasing system reliability.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for cellular network mobility management based on user equipment measurements comprises:
a host device;
one or more cellular communication cells;
a back office;
one or more controllers, the one or more controllers disposed within the host device and within the back office, each of the one or more controllers has a processor, a memory, and input/output (I/O) ports, the processor executing programmatic control logic stored in the memory, the I/O ports in wireless communication via a cellular network with the one or more cellular communication cells and the back office, the programmatic control logic including a cellular network mobility management application (CMMA), the CMMA comprising:
a first control logic, initiated by the host device, for generating control-plane measurement event based handover suggestions;
a second control logic, initiated by the host device, for generating quality-of-service (QoS) measurement based handover suggestions; and
a third control logic, initiated by the one or more cellular communication cells, for performing cellular network signal strength monitoring and for determining that a measurement configuration (MC) threshold has been achieved; and
wherein outputs of the third control logic are further modified by a fourth control logic that performs anomaly detection; and in response to outputs of the first control logic, the second control logic, the third control logic, and the anomaly detection, the system selectively alters timing of cellular network handovers between the host device and the one or more cellular communication cells to reduce a potential for repetitive handovers from a first level to a second level less than the first level while maintaining or improving a cellular network QoS.

2. The system of claim 1 wherein the memory further comprises:
one or more databases of the back office storing prior knowledge, the prior knowledge including historical information from the host device and from other devices communicating on the cellular network, the historical information comprising: QoS information, cellular network signal strength information, and host device state information;
the host device state information comprising: static and dynamic information about the host device including velocity, distance from the host device to a suggested handover location, a host device location, and a network signal strength and network condition at a current host device location.

3. The system of claim 2, wherein the first control logic further comprises:
control logic that receives a radio resource control (RRC) message from at least one cellular communication cell of the cellular network;
control logic that, based on the RRC message generates an original MC and transmits the original MC to the host device; and
control logic that identifies events and event thresholds relevant to identified events, the event thresholds stored in the memory.

4. The system of claim 3, further comprising:
control logic for performing event-based threshold modification utilizing the identified events and event thresholds; and
control logic for determining a handover suggestion, wherein the handover suggestion comprises at least one of: preponing a handover, postponing a handover, canceling a handover, and adding a handover.

5. The system of claim 4, wherein the event-based threshold modification further comprises:
control logic for generating a suggested MC that causes a measurement report (MR) for each monitored physical cell to trigger at time tₛ(1), and based on the MR, initiates a handover at time tₛ(2), in context, t(2)=t(1)⁺, defines that a handover occurs at t(2) takes place shortly after t(1), where t(1) is the time at which the MR is triggered such that:
a preponed handover is defined as: tₛ(2)<tₒ(2);
a postponed handover is defined as: tₛ(2)>tₒ(2);
a cancelled handover is defined as: tₛ(1)=inf;
and adding a handover is defined as: ∃tₛ(2) when [symbol] tₒ(2),
where tₒ(2) indicates the timing of the original handover.

6. The system of claim 1, wherein the second control logic further comprises:
control logic for monitoring cellular network QoS, and upon determining that a predetermined QoS threshold has not been met, continues QoS monitoring, and upon determining that the predetermined QoS threshold has been met, engages a determinator control logic, wherein the cellular network QoS includes data throughput, end-to-end latency, jitter, and communication reliability.

7. The system of claim 6, wherein the second control logic further comprises:
control logic that monitors cellular network signal strength as reference signal perceived power (RSRP), and upon determining that predetermined signal strength thresholds have not been met, continues RSRP monitoring, and upon determining that the predetermined signal strength thresholds have been met, engages the determinator control logic; and
control logic that determines whether events have met MC thresholds set in an original MC, and upon determining that the MC thresholds have not been met, continues RSRP monitoring, and upon determining that the MC thresholds have been met, triggers an MR.

8. The system of claim 7, wherein the determinator control logic further comprises:
control logic that incorporates a QoS metric within decision-making criteria for the MR, wherein:
when QoS metrics fall below Q_{θ} prior to RSRP decreasing enough to trigger a handover according to the MC thresholds in the original MC, a handover process is advanced or preponed;
when QoS metrics fall below Qₘᵢₙ, the control-plane events that responsible for emergency handover are kept or created in the MC, and the handover process is advanced or preponed; and
when QoS metrics are above Qₘᵢₙ, and RSRP anomalies are detected, then the handover process is cancelled or postponed, wherein RSRP anomalies define short duration signal strength fluctuations, Qₘᵢₙ is a predetermined minimum QoS, and Q_{θ} is a predetermined threshold QoS greater than Qₘᵢₙ.

9. The system of claim 8, further comprising control logic for detecting repetitive unnecessary handovers or ping-pong handovers between cells such that for a physical cell identity (PCI) at time T: P(T),
If ∃T_{AB}, T_{BA} such that:
$$\begin{matrix}P ( {T}_{A B} ) = A and P ( {T}_{A B}^{+} ) = B ; \\ P ( {T}_{B A} ) = B and P ( {T}_{B A}^{+} ) = A ; \\ {T}_{B A}^{+} - {T}_{A B} < t ,\end{matrix}$$
then: Ping-Pong=True.

10. The system of claim 9, wherein the third control logic further comprises:
control logic for adjusting a location of a handover between cellular communication cells upon detection of a ping-pong handover such that:
If Ping-Pong=True:
$$A {3}_{θ} := min ( A {3}_{θ} + ( \frac{{𝓌}_{v}}{V + ϵ} ) ( {𝓌}_{d} D ) , A {3}_{θ} + {Δ}_{max} ) ,$$
where v=velocity, D=estimated distance to a heatmap+host device trajectory, wᵥ=velocity weight, ϵ=small constant, w_{d}=distance weight, Δₘₐₓ=a maximum allowed modification, where wᵥ, w_{d}, Δₘₐₓ≥0,ϵ>0.

11. A method for cellular network mobility management based on user equipment measurements comprises:
executing programmatic control logic including a cellular network mobility management application (CMMA) stored in memory of one or more controllers, the one or more controllers disposed within a host device and within a back office, each of the one or more controllers has a processor, a memory, and input/output (I/O) ports, the processor executing the programmatic control, the I/O ports in wireless communication via a cellular network with the one or more cellular communication cells and the back office, the CMMA including control logic for:
generating, by the host device, control-plane measurement event based handover suggestions;
generating, by the host device, quality-of-service (QoS) measurement based handover suggestions; and
performing, by the one or more cells, cellular network signal strength monitoring and determining that a measurement configuration (MC) threshold has been achieved; and
performing anomaly detection; and selectively altering timing of cellular network handovers between the host device and the one or more cellular communication cells to reduce a potential for repetitive handovers from a first level to a second level less than the first level while maintaining or improving a cellular network QoS.

12. The method of claim 11 further comprising:
storing, with one or more databases of the back office, prior knowledge, the prior knowledge including historical information from the host device and from other devices communicating on the cellular network, the historical information comprising: QoS information, cellular network signal strength information, and host device state information;
the host device state information comprising: static and dynamic information about the host device including velocity, distance from the host device to a suggested handover location, a host device location, and a network signal strength and network conditions at a current host device location.

13. The method of claim 12, further comprising:
receiving a radio resource control (RRC) message from at least one cellular communication cell of the cellular network;
generating, based on the RRC message, an original MC and transmitting the original MC to the host device; and
identifying events and event thresholds relevant to identified events, the event thresholds stored in the memory.

14. The method of claim 13, further comprising:
performing control-plane event-based threshold modification utilizing the identified events and event thresholds; and
determining a handover suggestion, wherein the handover suggestion comprises at least one of: preponing a handover, postponing a handover, canceling a handover, and adding a handover.

15. The method of claim 14, further comprising:
generating a suggested MC that causes measurement report (MR) for each monitored physical cell to trigger at time tₛ(1), and based on the MR, initiating a handover at time tₛ(2), wherein in context, t(2)=t(1)⁺, defines that a handover occurs at t(2) takes place shortly after t(1), where t(1) is a time at which the MR is triggered such that:
a preponed handover is defined as: tₛ(2)<tₒ(2);
a postponed handover is defined as: tₛ(2)>tₒ(2);
a cancelled handover is defined as: tₛ(1)=inf;
and adding a handover is defined as: ∃tₛ(2) when [symbol] tₒ(2).

16. The method of claim 11 further comprising:
monitoring cellular network QoS, and upon determining that a predetermined QoS threshold has not been met, continuing QoS monitoring, and upon determining that the predetermined QoS threshold has been met, engaging a determinator control logic, wherein the cellular network QoS includes data throughput, end-to-end latency, jitter, and communication reliability).

17. The method of claim 16, further comprising:
monitoring cellular network signal strength as reference signal perceived power (RSRP), and upon determining that predetermined signal strength thresholds have not been met, continuing RSRP monitoring, and upon determining that the predetermined signal strength thresholds have been met, engaging the determinator control logic; and
determining whether events have met MC thresholds set in an original MC, and upon determining that the MC thresholds have not been met, continuing RSRP monitoring, and upon determining that the MC thresholds have been met, triggering an MR.

18. The method of claim 17, further comprising:
incorporating a QoS metric within decision-making criteria for the MR, wherein:
advancing or preponing a handover process when QoS metrics fall below Q_{θ} prior to RSRP decreasing enough to trigger a handover according to the MC thresholds in the original MC;
advancing or preponing the handover process when QoS metrics fall below Qₘᵢₙ, only a portion of events are kept in the MC; and
cancelling or postponing the handover process when QoS metrics are above Qₘᵢₙ, and RSRP anomalies are detected, wherein RSRP anomalies define short duration signal strength fluctuations, Qₘᵢₙ is a predetermined minimum QoS, and Q_{θ} is a predetermined threshold QoS greater than Qₘᵢₙ.

19. The method of claim 18, further comprising:
detecting repetitive unnecessary handovers or ping-pong handovers between cells such that for a physical cell identity (PCI) at time T: P(T),
When ∃T_{AB}, T_{BA} such that:
$$\begin{matrix}P ( {T}_{A B} ) = A and P ( {T}_{A B}^{+} ) = B ; \\ P ( {T}_{B A} ) = B and P ( {T}_{B A}^{+} ) = A ; \\ {T}_{B A}^{+} - {T}_{A B} < t ,\end{matrix}$$
then: Ping-Pong=True; and
adjusting a location of a handover between cells upon detection of a ping-pong handover such that:
When Ping-Pong=True:
$$A {3}_{θ} := min ( A {3}_{θ} + ( \frac{{𝓌}_{v}}{V + ϵ} ) ( {𝓌}_{d} D ) , A {3}_{θ} + {Δ}_{max} ) ,$$
where v=velocity, D=estimated distance to a heatmap+host device trajectory, wᵥ=velocity weight, ϵ=small constant, w_{d}=distance weight, Δₘₐₓ=a maximum allowed modification, where wᵥ, w_{d}, Δₘₐₓ≥0,ϵ>0.

20. A method for cellular network mobility management based on user equipment measurements comprises:
executing programmatic control logic including a cellular network mobility management application (CMMA) stored in memory of one or more controllers, the one or more controllers disposed within a host device and within a back office, each of the one or more controllers has a processor, a memory, and input/output (I/O) ports, the processor executing the programmatic control, the I/O ports in wireless communication via a cellular network with the one or more cellular communication cells and the back office, the CMMA including control logic for:
generating, by the host device, measurement event based handover suggestions, including:
storing, with one or more databases of the back office, prior knowledge, the prior knowledge including historical information from the host device and from other devices communicating on the cellular network, the historical information comprising: QoS information, cellular network signal strength information, and host device state information;
the host device state information comprising: static and dynamic information about the host device including velocity, distance from the host device to a suggested handover location, a host device location, and a network signal strength and network condition at a current host device location;
receiving a radio resource control (RRC) message from at least one cellular communication cell of the cellular network;
generating, based on the RRC message, an original MC and transmitting the original MC to the host device;
identifying events and event thresholds relevant to identified events, the event thresholds stored in the memory;
performing control-plane event-based threshold modification utilizing the identified events and event thresholds;
determining a handover suggestion, wherein the handover suggestion comprises at least one of: preponing a handover, postponing a handover, canceling a handover, and adding a handover;
generating a suggested MC that causes measurement report (MR) for each monitored physical cell to trigger at time tₛ(1), and based on the MR, initiating a handover at time tₛ(2), in context, t(2)=t(1)⁺, defines that a handover occurs at t(2) takes place shortly after t(1), where t(1) is the time at which the MR is triggered) such that:
a preponed handover is defined as: tₛ(2)<tₒ(2);
a postponed handover is defined as: tₛ(2)>tₒ(2);
a cancelled handover is defined as: tₛ(1)=inf;
and adding a handover is defined as: ∃tₛ(2) when [symbol] tₒ(2);
generating, by the host device, quality-of-service (QoS) measurement based handover suggestions, and performing, by the one or more cells, cellular network signal strength monitoring and determining that a measurement configuration (MC) threshold has been achieved, including:
monitoring cellular network QoS, and upon determining that a predetermined QoS threshold has not been met, continuing QoS monitoring, and upon determining that the predetermined QoS threshold has been met, engaging a determinator control logic, wherein the cellular network QoS includes data throughput, end-to-end latency, jitter, and communication reliability; monitoring cellular network signal strength as reference signal perceived power (RSRP), and upon determining that predetermined signal strength thresholds have not been met, continuing RSRP monitoring, and upon determining that the predetermined signal strength thresholds have been met, engaging the determinator control logic;
determining whether events have met MC thresholds set in an original MC, and upon determining that the MC thresholds have not been met, continuing RSRP monitoring, and upon determining that the MC thresholds have been met, triggering an MR;
incorporating a QoS metric within decision-making criteria for the MR, wherein:
advancing or preponing a handover process when QoS metrics fall below Q_{θ} prior to RSRP decreasing enough to trigger a handover according to the MC thresholds in the original MC;
advancing or preponing the handover process when QoS metrics fall below Qₘᵢₙ, a portion of the control-plane events that are responsible for emergency handover are kept or created in the MC;
cancelling or postponing the handover process when QoS metrics are above Qₘᵢₙ, and RSRP anomalies are detected, wherein RSRP anomalies define short duration signal strength fluctuations, Qₘᵢₙ is a predetermined minimum QoS, and Q_{θ} is a predetermined threshold QoS greater than Qₘᵢₙ;
detecting repetitive unnecessary handovers or ping-pong handovers between cells such that for a physical cell identity (PCI) at time T: P(T),
$$\begin{matrix}When ∃ {T}_{A B} , {T}_{B A} such that : \\ P ( {T}_{A B} ) = A and P ( {T}_{A B}^{+} ) = B ; \\ P ( {T}_{B A} ) = B and P ( {T}_{B A}^{+} ) = A ; \\ {T}_{B A}^{+} - {T}_{A B} < t ,\end{matrix}$$
then: Ping-Pong=True; and
performing anomaly detection; and selectively altering timing of cellular network handovers between the host device and the one or more cells to reduce a potential for repetitive handovers from a first level to a second level less than the first level while maintaining or improving a cellular network QoS by adjusting a location of a handover between cells upon detection of a ping-pong handover such that:
When Ping-Pong=True:
$$A {3}_{θ} := min ( A {3}_{θ} + ( \frac{{𝓌}_{v}}{V + ϵ} ) ( {𝓌}_{d} D ) , A {3}_{θ} + {Δ}_{max} ) ,$$
where v=velocity, D=estimated distance to a heatmap+host device trajectory, wᵥ=velocity weight, ϵ=small constant, w_{d}=distance weight, Δₘₐₓ=a maximum allowed modification, where wᵥ, w_{d}, Δₘₐₓ≥0,ϵ>0.
